(19) United States
(12) Patent Application Publication
(10) Pub. No.: US 2014/0214435 A1
(43) Pub. Date: Jul. 31, 2014

(54) Universal Prescription Co-Pay Offset System and Methods for Using Same

(71) Applicant: Robert G. Previdi, Naples, FL (US)

(72) Inventor: Robert G. Previdi, Naples, FL (US)

(21) Appl. No.: 13/752,308

(22) Filed: Jan. 28, 2013

(51) Int. Cl. G06F 19/00; G06Q 50/22

(52) U.S. Cl. CPC G06F 19/3456; G06Q 50/22
USPC 705/2

(57) ABSTRACT

A method for submitting a claim to a plurality of incentive programs to off-set a patient's financial responsibility for a pharmaceutical prescription, comprising: commencing the filling of a patient prescription; submitting at least a claim for the prescription, using a pre-programmed claim submission system, to a Universal Plan comprised of a plurality of incentive programs using a single Universal BIN associated to the Universal Plan by the claim submission system; receiving a claim response from the Universal Plan; and, charging the patient based on information received in the claim response from the Universal Plan.

### FIELD AND BACKGROUND OF THE INVENTION

The present invention, in some embodiments thereof, relates to the prescription pharmaceutical industry and, more particularly, but not exclusively, to a system and methods for making the prescription processing more efficient and/or beneficial to the involved participants and/or to enhance patient compliance with pharmaceutical prescriptions.

A prescription pharmaceutical claim processing system is used throughout the United States of America for adjudicating claims which generally follow a conventional format. A typical claim today includes patient information and/or cardholder ID, information about which pharmaceutical was prescribed and also includes a Bank Identification Number (“BIN”), and a Processor Control Number (“PCN”) and/or a Group number, which are hierarchical. That is, routing proceeds serially from the BIN to the PCN to the Group #.

The BIN used today is a 5 digit number wherein each BIN is associated with a payer (e.g. health insurance company). For example, South Carolina Medicare has a different and unique BIN from another payer, such as Independence Blue Cross Blue Shield. Bach payer has selected a Pharmacy Benefit Manager (“PBM”) who is a company that only handles prescription medication billing. Each payer uses one PBM for claims processing, however more than one payer may use the same PBM. The BIN number indicates to which PBM a pharmacist sends the prescription claim.

As a subset to the BIN, the PBM/Processor will most likely also require a PCN. The PCN is used internally by the PBM to route the claim. Most PBM's use PCNs due to the large volume of information which needs to be organized and processed automatically by the PBM.

The Group # is typically where specific plan rules are maintained, for example the co-pay amount or the % discount

Some PBMs/Processors only require the BIN and PCN and will “find” the group/plan based upon other submitted data, such as the cardholder ID. There are few PBM/Processors that require the BIN only, but the reason why they only require the BIN is because they are only single-plan programs and no further, internal organization at the PBM is necessary or even desired.

From a pharmacy's standpoint the large chain headquarters or independent pharmacies use software on their claims processing/submission systems whereby the chains and the software vendors for these pharmacies are continually made aware of new Payers/Plans. The chains and/or software vendors regularly update the software of the claims processing/submission systems to include the new Payer/Plans. Those Plans are each identifiable by a NAME that is then associated to either a BIN (only) or a BIN+PCN. The chains and software vendors will set these up in their pharmacy systems so that pharmacist can locate a specific single Plan by NAME (or sometimes BIN). For most prescription fills today, the pharmacist finds an individual Payer/Plan by NAME. Some software (especially for independent pharmacies) allows pharmacists to hand enter the BIN and/or PCN to submit a claim, if they cannot find the plan by NAME.

From a patient and/or customer standpoint, the patient must typically have a pharmacy benefit card to present to the pharmacist which contains at least some or all of the information described above, cardholder ID, BIN, PCN, Group # and sometimes more.

### SUMMARY OF THE INVENTION

An aspect of some embodiments of the invention relates to providing a method for submitting prescription pharmaceutical claims to a plurality of Payers and/or Plans using only a BIN and information to identify the pharmaceutical. In some embodiments of the invention, the BIN is a Universal BIN which is used to direct claims processing to a Universal Plan which contains within it the plurality of different plans. Optionally, the different plans are for a plurality of different pharmaceuticals and/or are offered by a plurality of different Payers. In an embodiment of the invention, information to identify the pharmaceutical is an NDC. In some embodiments of the invention, the Plans and/or Payers are for discount and/or incentive pharmaceutical programs.

In an embodiment of the invention, a patient's prescription is filled by a pharmacist. The pharmacist optionally submits a claim to the patient's primary payer, for example a health insurance company and receives back an indication (e.g. a claim response) of how much the patient has to pay after the primary payer claim is adjudicated (i.e. processed by the PBM, et al.).

In an embodiment of the invention, the pharmacist submits and/or transmits a claim (a transaction) to the Universal Plan using only the Universal BIN and information to identify the pharmaceutical, or pharmaceuticals, for example an NDC number. The pharmacist receives a claim response, optionally in the form of an incentive coupon and/or coupon information for taking advantage of the incentive or discount, in return to a claim submission. In an embodiment of the invention, there are at least three possible scenarios for giving the patient the best result (usually price). First, the pharmacist receives back the incentive program claim information after it has been adjudicated, and combines the inventive program claim response (akin to the coupon used in today's pharmaceutical incentive/discount industry) with the primary payer claim response in order to offset the primary payer co-payment with the incentive program benefit. In a second scenario, there is no incentive program running for the pharmaceutical submitted to the Universal Plan (i.e. there is no Payer/Plan in the Universal Plan which applies), so there is no benefit to the patient and only the primary payer co-payment is charged to the patient. In a third scenario, it is possible that an incentive program is running for the pharmaceutical which would provide at least as good a result as the first scenario. Thus, in a third scenario, it is possible that pharmacist only applies the incentive program claim response to the patient's bill in order to receive the best result to save the step of having to combine the primary payer claim response with the incentive program claim response and/or if the pharmacist skipped submitting a primary payer claim in the first place.

In an embodiment of the invention, more than one transaction or claim is submitted to the Universal Plan in a single transmission. The claim submission from the pharmacy to the Universal Plan optionally includes claim information for a plurality of pharmaceuticals. In an embodiment of the invention, the plurality of claims included in the single transmission is processed contemporaneously and/or simultaneously and/or a single claim response tor the plurality of claims is transmitted back to the claim submitter. In an embodiment of the invention, multiple claim responses are returned to the claim submitter, for example, one claim response for each claim submitted, even though the claims were submitted in a single transmission originally.

In some embodiments of the invention, included in a claim response is a recommendation and/or suggestion for products and/or other pharmaceuticals that are related and/or could be substitutes for the drug which was the subject of the submitted claim. For example, a claim is submitted for Nexium® and included in the claim response is a suggestion that Prilosec® could be used instead. Optionally, a suggestion is provided if there is no program running for the originally submitted drug (i.e. scenario two, above). Optionally, a suggestion is provided if there is a more advantageous program naming for an equivalent drag, For example if Prilosec® would be cheaper than Nexium® as a result of a more aggressive incentive program/plan available in the Universal Plan.

An aspect of some embodiments of the invention relates to providing a method for organizing prescription pharmaceutical Plans and/or Payers by associating a plurality of individual Plans and/or Payers with a single Universal BIN associated with a Universal Plan. In some embodiments of the invention, the Plans and/or Payers are for discount and/or incentive pharmaceutical programs. In an embodiment of the invention, multiple plans, possibly offered by multiple Payers, are placed in a single organizational construct (the Universal Plan) within a PBM such that any claim to any Plan and/or Payer which is a party to the Universal Plan is submitted using the Universal BIN.

An aspect of some embodiments of the invention relates to increasing patient compliance with prescription medication plans created by health care professionals by making it easier and cheaper for the patient to fill prescriptions. In an embodiment of the invention, by providing a Universal Plan with a Universal BIN which includes multiple incentive plans and/or Payers within the Universal Plan, pharmacists can fill the patient's prescription more efficiently and with a realized cost benefit to the patient.

An aspect of some embodiments of the invention relates to providing a system for submitting and/or processing prescription pharmaceutical claims to a plurality of Payers/Plans using only a single BIN and information to identify the pharmaceutical. In an embodiment of the invention, at least one computer of a prescription pharmaceutical claims submitting and/or processing system is located at a pharmacy and programmed to associate a plurality of Plans and/or Payers with a single Universal Plan which is identified by a single BIN, a Universal BIN. In an embodiment of the invention, any pharmacy can be provided with the at least one programmed computer allowing the system to function in any pharmacy environment. In an embodiment of the invention, the Universal BIN routes the claim submitted by the pharmacy via a communications network of the system for adjudicating prescription pharmaceutical claims to a PBM. The internal processing hardware at the PBM, in some embodiments of the invention, is also programmed to associate the plurality of Plans and/or Payers with the Universal BIN so that incoming claims requests directed to that Universal BIN, which also have enough information to identify which specific pharmaceutical was purchased by the patient, will be adjudicated by the PBM applying the rules of the Plan or Plans which apply to that pharmaceutical. In some embodiments of the invention, the at least one computer is also programmed to automatically calculate the best outcome for the patient factoring in at least one of a primary payer claim, an incentive program claim and/or a combination of both claims.

An aspect, of some embodiments of the invention relates to providing better management of patient utilization across multiple pharmaceuticals within the same Universal Plan and/or program, for example by creating a patient portfolio that is based on a plurality of claims submitted to the Universal Plan, in some embodiments of the invention, the patient portfolio is used, for example, to help detect dreg interaction issues, to monitor patient compliance with prescriptions, and/or to help identify product tie-ins, supplements and/or substitutes. In an embodiment of the invention, a patient portfolio is created for a patient from the time an initial incentive claim is submitted to the Universal Plan. Optionally, the patient portfolio based on the Universal Plan is linked or merged with another portfolio which has been created by a pharmacy, processor and/or a pharmaceutical manufacturer and/or other related entity. In an embodiment of the invention, fully featured patient utilization is implemented only after the patient opts in to the a program and/or only with certain implemented patient privacy controls.

There is provided in accordance with an embodiment of the invention, a method for submitting a claim to a plurality of incentive programs to off-set a patient's financial responsibility for a pharmaceutical prescription, comprising: commencing the filling of a patient prescription; submitting at least a claim tor the prescription, using a pre-programmed claim submission system, to a Universal Plan comprised of a plurality of incentive programs using a single Universal BIN associated to the Universal Plan by the claim submission system; receiving a claim response from the Universal Plan; and, charging the patient based on information received in the claim response from the Universal Plan.

In an embodiment of the invention, the method further comprises submitting a primary payer claim.

In an embodiment of the invention, the charging is based on information received from adjudicated claims submitted to at least one of the primary payer and the Universal Plan.

In an embodiment of the invention, the submitting is performed using only the Universal BIN and drug identification information.

In an embodiment of the invention, the receiving a claim response incorporates the application of at least one rule.

In an embodiment of the invention, at least one rule is a Program Rule or a Pharmacy Rule.

In an embodiment of the invention, the method further comprises creating a patient profile based on at least one filling of a prescription by the patient. In an embodiment of the invention, the method further comprises offering at least one additional incentive to the patient based on the patient's profile. Optionally, the patient voluntarily enrolls in a program to utilize information in the patient profile. Optionally, at least some of the patient profile is encoded to enhance patient privacy.

There is further provided in accordance with an embodiment of the invention, a method for organizing prescription pharmaceutical plans, comprising: associating a plurality of individual plans with a single Universal Plan; and, associating the Universal Plan with a single Universal BIN routed to a single PBM.

In an embodiment of the invention, the plurality of individual plans is offered by a plurality of different payers.

In an embodiment of the invention, a claim submitted to the Universal Plan is processed for applicability to each of the plurality of individual plans associated with the Universal Plan.

There is further provided in accordance with an embodiment of the invention, a method for increasing patient compliance with a health care professional created prescription medication treatment plan, comprising: providing a Universal Plan with a Universal BIN, wherein multiple incentive programs are associated with the Universal Plan; filling a patient prescription at a pharmacy; submitting a pharmaceutical benefit claim for the filled patient prescription using a pre-programmed claim submission system at the pharmacy; and, increasing patient compliance by saving the patient money as a result of submitting the pharmaceutical benefit claim and receiving an adjudicated claim response which applies an incentive coupon to the prescription.

In an embodiment of the invention, the incentive coupon is a prior authorization coupon.

There is further provided in accordance with an embodiment of the invention, a system for processing prescription pharmaceutical claims submitted to a plurality of plans, comprising: at least one claim submitting computer located at a pharmacy, programmed with a Universal BIN associated with a Universal Plan comprised of a plurality of Incentive plans; a PBM configured to process a Universal Plan claim by identifying at least one drug which is the subject of the claim, wherein the Universal Plan is organized at the PBM to include a plurality of incentive plans; and, a communications network operatively connected to the at least one computer and the PBM for relaying information between them.

In an embodiment of the invention, the at least one computer is provided with a memory for storage of at least one of a software for programming the computer, patient information and rules.

In an embodiment of the invention, the information is comprised of a transmission of a claim from the pharmacy and a claim response to the pharmacy from the PBM.

In an embodiment of the invention, the system further comprises a pharmaceutical manufacturer in communication with at least one of the pharmacy and the PBM for the transmission of rules and patient information.

In an embodiment of the invention, the system further comprises a primary payer in communication with at least one of the pharmacy and the PBM for processing a primary payer claim alternatively, additionally or preceding a claim to the Universal Plan.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings or figures. With specific reference now to the drawings in detail, it is stressed that the particulars shown are by way of example, are not necessarily to scale, and are for purposes of illustrative discussion of embodiments of the invention. In this regard, the description taken with the drawings makes apparent to those skilled in the art how embodiments of the invention may be practiced.

In the drawings:

FIG. 1A is a schematic view showing a prior art method for providing pharmaceutical incentive benefits to a patient;

FIG. 1B is a schematic view showing a method for providing pharmaceutical incentive benefits to a patient to offset the patient's financial responsibility for a prescription, in accordance with an exemplary embodiment of the invention;

FIG. 2A is a schematic prior art view showing how an incentive program claim is processed;

FIG. 2B is a schematic view showing how an incentive program claim is processed, in accordance with an exemplary embodiment of the invention;

FIG. 3A is a block diagram showing a prior art methodology for organizing incentive programs;

FIG. 3B is a is a block diagram showing a methodology for organizing incentive programs, In accordance with an exemplary embodiment of the invention;

and,

FIG. 4 is a flowchart of a method, of billing for filling a prescription In a co-pay offset system, in accordance with an exemplary embodiment of the invention.

### DESCRIPTION OP SPECIFIC EMBODIMENTS OF THE INVENTION

The present invention, in some embodiments thereof relates to the prescription pharmaceutical industry and, more particularly, but not exclusively, to a system and methods for making the prescription processing more efficient and/or beneficial to the involved participants and/or to enhance patient compliance with pharmaceutical prescriptions.

In some embodiments of the invention, new methodologies and/or a new system are provided to make pharmaceutical claim submission easier, to simplify the prescription filling process, to enhance patient compliance with prescriptions, to increase sales of incentivized pharmaceuticals and/or to save patient's money.

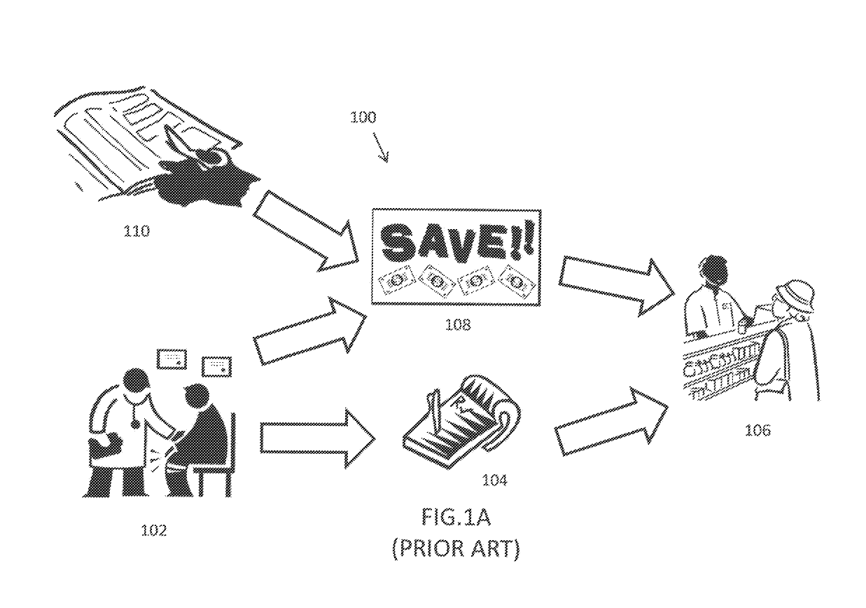

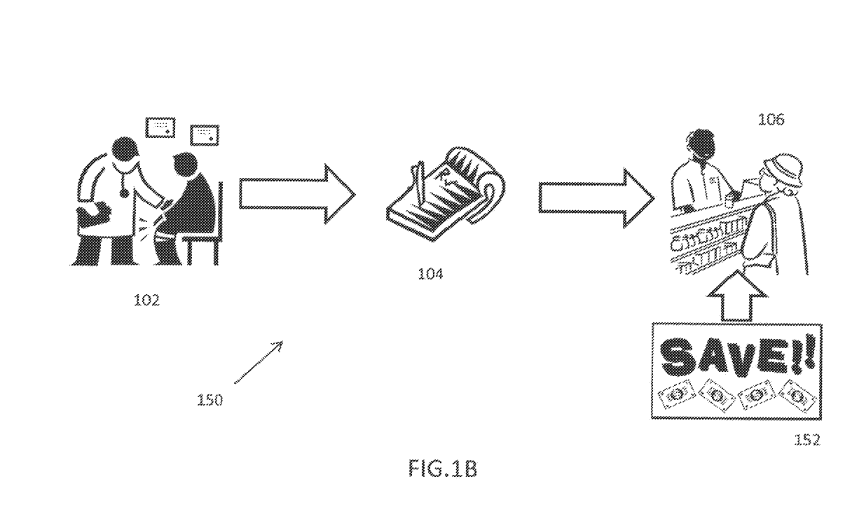

For purposes of better understanding some embodiments of the present invention, as illustrated in FIGS. 1B, 2B, 3B and 4 of the drawings, reference is first made to the how incentive and discount coupon programs are currently organized and/or administered, as illustrated in FIGS. 1A, 2A, and 3A.

FIG. 1A is a schematic view 100 showing a prior art method for providing pharmaceutical incentive coupon benefits to a patient. Upon an encounter (102) with a health care professional, for example a doctor, a patient is written (104) a prescription for a pharmaceutical. Often in an incentive coupon scenario, the health care professional presents (108) the patient with a coupon which could save the patient money when the patient goes to fill (106) the prescription at a pharmacy. In some incentive coupon scenarios, the coupon is provided to the patient through non-health care professional based advertising or marketing efforts (110), for example the coupon is clipped from a publication or it comes in a mailer like Valpak®. The patient takes the coupon, either given (108) by the health care professional or provided (110) by a marketing effort to the pharmacy when the prescription is being filled (106). The pharmacist fills (106) the prescription and during the filing of the claims process, uses the information included on the incentive coupon to render a discount or incentive to the patient for having filled the prescription.

The prior art method for providing incentive coupon benefits suffers from some drawbacks including, but not limited to, the frequent forgetting of patients to present the coupon before the pharmacist submits the prescription claim to the relevant payers, such that the claim response is returned and the patient's filling of the prescription is processed entirely before the coupon, information is accounted for. A variation on this theme is the pharmacist processes the prescription pursuant to a prescription being called in or e-filed and then after the prescription has been entirely processed and is ready for pick-up, the patient walks in with a coupon. In both scenarios, this causes the pharmacist to have to reverse the previous filed claim or claims and then resubmit using the coupon information in order to get a discount for the patient.

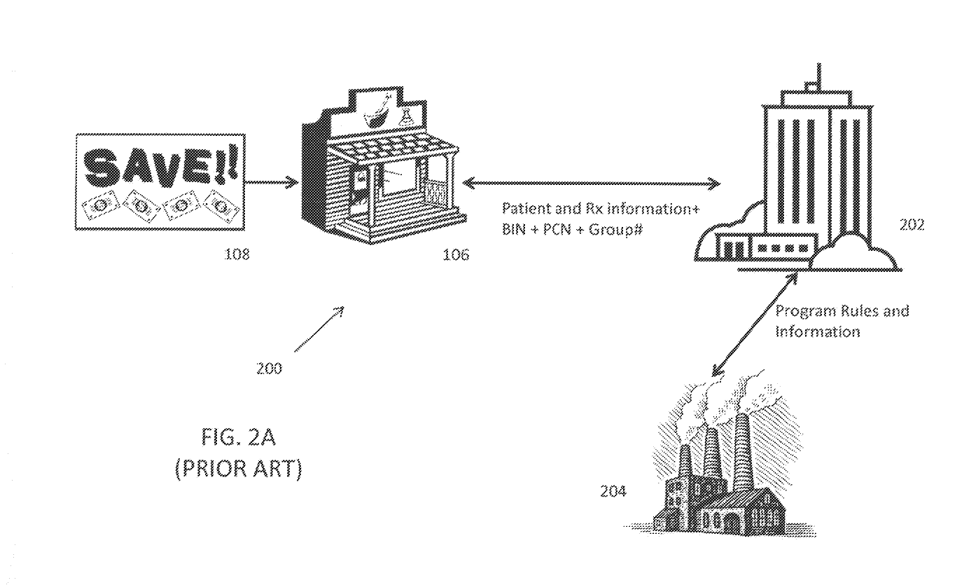

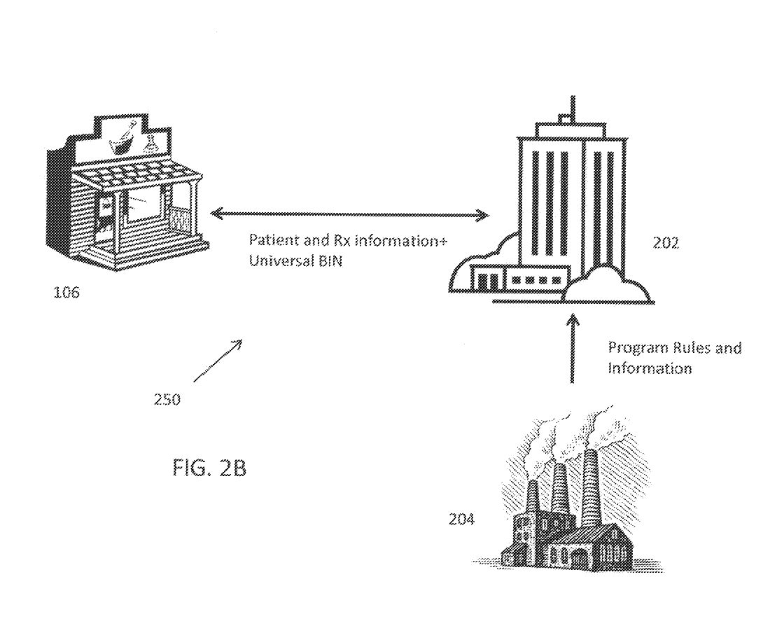

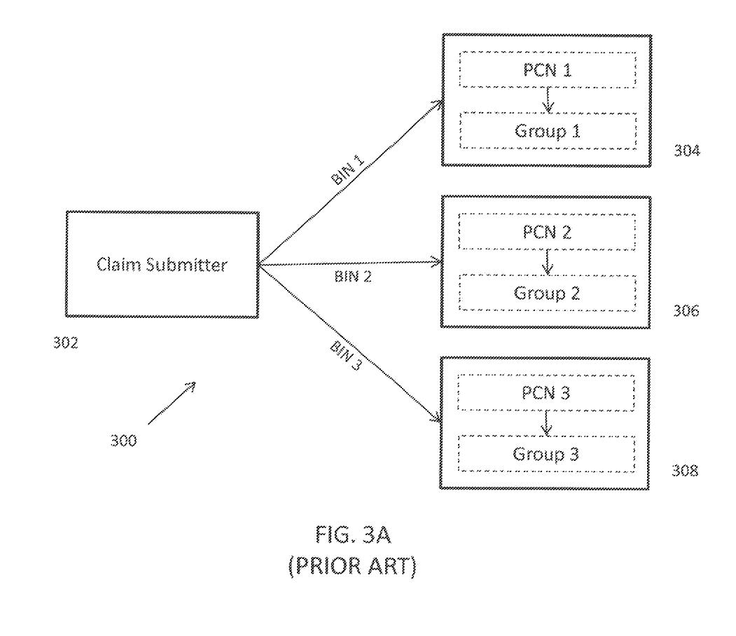

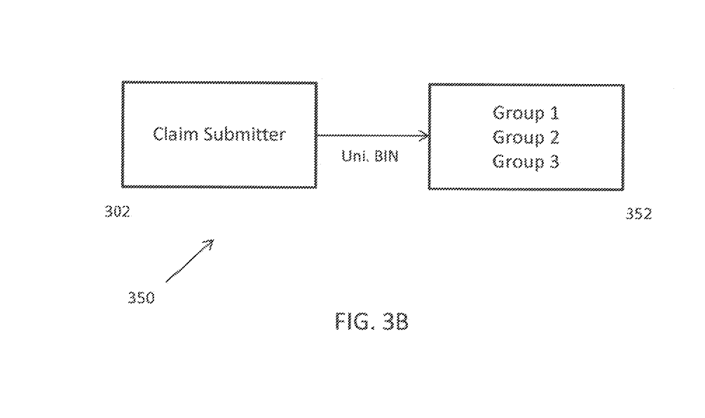

FIG. 2A is a schematic prior art view 200 showing how art incentive program claim is currently processed. As described above with respect to FIG. 1A, the patient presents (108) an incentive coupon to the pharmacist 106 which includes program information about the specific incentive or discount program to which the coupon applies. This program information customarily includes at least a couple of: cardholder ID, a BIN, a PCN and a Group number. Typically, all are included on the coupon in order for the claim to be processed efficiently and correctly, as each separate piece of the program information routes the claim in a serial fashion through various steps (e.g. BIN to PCN to Group #, shown and described in more detail with respect to FIG. 3A). The pharmacist takes this program information and enters it into a claims processing system, along with patient and prescription information, wherein the discount program claim is sent to a PBM or Processor 202 for adjudication. The PBM 202 determines if the incentive/discount program applies to the pharmaceutical (using a National Drug Code (NDC) number) and if it does the PBM then applies the rules of the incentive/discount program to the claim. The rules of the incentive/discount program are typically supplied to the PBM 202 by the pharmaceutical manufacturer 204. Once the PBM 202 adjudicates the claim, the information is returned to the pharmacy 106 so that the pharmacist can instruct the patient how much is owed and how much was covered by the program.

FIG. 3A is a block diagram 300 showing a prior art methodology tor organizing incentive programs and consequently how claims had to be submitted previously. A claim submitter 302, for example the pharmacist at a pharmacy 106, receives an incentive coupon from a patient who has brought the coupon with them to the pharmacy 106. After filling the patient's prescription, the claim submitter 302 enters the incentive claim into the claims adjudication system. Using the program information which is included on the coupon, starting with the BIN, the claim moves from step to step within the claims adjudication system. In the diagram 300, three (3) different PBMs, addressed by three different BINs are shown although there exist hundreds or even thousands of BINS in the industry today. Depending on which BIN is entered (BIN 1, BIN 2 or BIN 3) the claim is routed to a specific, possibly different, PBM 304, 306, 308, respectively, since each payer which is represented by a BIN usually uses only a single PBM. Within the PBM, a PCN is used to further route the claim within the PBM, eventually landing at a Group number. Often, for each individual drug prescription which is being filled, the claim submitter 302 will have to submit a separate claim since the BIN, PCN and/or Group # is likely to be different.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of oilier embodiments or of being practiced or carried out in various ways.

FIG. 1B is a schematic view showing a method 150 for providing pharmaceutical incentive benefits to a patient to offset the patient's financial responsibility for a prescription, in accordance with an exemplary embodiment of the invention. The description of FIG. 1B is in contrast to that of FIG. 1A, wherein in an embodiment of the invention, an actual, physical discount or incentive program coupon does not have to be given to the patient by the health care professional or provided to the patient by a marketing effort. In an embodiment of the invention, the patient encounters (102) a health care professional who then writes (104) a prescription for the patient to treat whatever ails the patient. The patient goes to the pharmacy to fill (106) the prescription, however, unlike in the procedure described in FIG. 1A, the patient does not need to physically take a discount or incentive program coupon into the pharmacy in order to reap its benefit because the discount or incentive program is already entered into the pharmacy's 106 claim submission/processing system by way of the Universal Plan 352 which is addressed using the Universal BIN. In an embodiment of the invention, the incentive coupon or voucher is thus entered into the process at the pharmacy, using the pharmacy's claim submission and/or processing system, not at the health care provider's office or from a public marketing campaign. In an embodiment of the invention, the claim submission and/or processing system is comprised of at least one controller or processor, such as a desktop computer. In an embodiment of the invention, the at least one controller or processor is pre-programmed with the Universal Plan's identifying information (including the Universal BIN) such that the pharmacist can easily submit claims to the Universal Plan using the system. In an embodiment of the invention, the system is provided with a memory. Optionally, the memory is used to store the software which programs the controller. Optionally, the memory is used to store rules (e.g. Pharmacy Rules) which are applied by the software. Optionally, the memory is used to store patient profile information.

In some embodiments of the invention, the claim submitter's claim submission system is programmed with software to automatically transmit an incentive claim to the Universal Plan regardless of the individual pharmacist's discretion.

In an embodiment of the invention, the process of FIG. 1B is distinguishable from the process of FIG. 1A at least because the pharmacist and/or pharmacy can control the couponing event and/or the decision whether to apply a coupon and/or the decision about which coupon to apply. More specifically, the Universal Plan 352 differs from other couponing systems/methods because the pharmacy 106 and/or the claim submitter 302 control patient access to the incentive programs. In an embodiment of the invention, because the “coupon” is available only through the pharmacy's claim submission system in the farm of the Universal Plan pre-entered into the system, it is entirely within the discretion of the pharmacist to decide if to submit an incentive claim to the Universal Plan and/or to notify the patient. If there is a program running and/or to notify the patient about related product tie-ins and other discounts. This is in contrast to now couponing methods currently work, wherein the patient brings the physical incentive coupon into the pharmacy or the health care provider transmits an e-coupon (which includes the standard Cardholder ID, BIN, PCN and Group #) with the e-prescription to the pharmacy, for which the pharmacy must submit a claim or suffer the patient's ire.

By giving the discretion to submit a claim to the Universal Plan to the pharmacist and/or the pharmacy 106, at least several benefits are realized, including:
1. Reducing the abandonment rate- According to a 2010 Wall Street Journal study, pharmacies suffer from an abandonment rate of approximate 10%, wherein one in ten new prescriptions filled by pharmacies are not picked up by patients, primarily because they refuse to pay the patient co-pay. In an embodiment of the invention, a pharmacist can choose to submit a claim to the Universal Plan if, in the pharmacist's discretion, the patient is at risk of abandoning the prescription at the pharmacy upon hearing the cost. In sours embodiments, the pharmacist stops patient abandonment in progress (e.g. the patient is walking away) by asking the patient to wait while the pharmacist submits a claim to see if discounts are available. In some embodiments of the invention, the pharmacist automatically submits a claim to the Universal Plan if the co-pay is over a certain amount (see discussion of applying rules, elsewhere herein).
2. Increasing pharmacy efficiency—In addition to lowering the abandonment rate, as described above, which reduces the amount of time and effort spent on filling prescriptions which are never picked up, in an embodiment of the invention, the pharmacist and/or pharmacy also reduces the incidences of having to reverse claims on filled prescriptions since the couponing claim is generated by the pharmacy and is not reliant on the patient presenting the coupon in a timely fashion.
3. Enhancing patient compliance with prescription regimens—Naturally, a patient is not properly adhering to a prescription medication regimen if the patient does not actually fill the prescription. By providing patients with easier access to incentive programs, costs can be reduced for the patient, thereby increasing the likelihood that the patient will pick up the prescription.
4. Enhancing patient brand loyalty—A certain segment of patients are very brand loyal and consequently ask their prescribing medical provider to prescribe a specific pharmaceutical. The pharmacist, taking advantage of the Universal Plan, can thus submit a claim to the Universal Plan without knowing if there is a program being run for that specific pharmaceutical just to see if there is some discount available to the patient for the patient requested pharmaceutical Patients knowing that the pharmacy could do all the work of finding out if there is a coupon allows the patient to feel more comfortable making a specific choice.
5. Saving the pharmacy money—In addition to decreasing the abandonment rate and wasting productivity by having the pharmacist reverse significant numbers of claims, in some instances an incentive program which is being run by a manufacturer simply won't make financial sense for the pharmacist and/or pharmacy. For example, to save the patient $2 would cost the pharmacy $7 in overhead expenses. In such a situation, the pharmacist could elect not to apply the coupon to the filled prescription. This could be implemented as a rule at the pharmacy level such as described elsewhere herein.

FIG. 2B is a schematic view 250 showing how a Universal Plan claim is processed, in accordance with an exemplary embodiment of the invention. Understanding of FIG. 2B is enhanced by contemporaneously describing FIG. 3B, which is a block diagram 350 showing a methodology for organizing incentive programs into a universal plan 352, in accordance with an exemplary embodiment of the invention. In an exemplary embodiment of the invention, rather than each incentive program being classified with its own BIN, PCN and Group #, such as shown in FIG. 3A, the Universal Plan 352 is set up which serves as a “holding tank” for a plurality of programs which are being contemporaneously run by at least one pharmaceutical manufacturer 204. In an embodiment of the invention, the Universal Plan 352 is administered by a single PBM and therefore requires only a single Universal BIN, which is specifically assigned to the Universal Plan 352. A benefit of this organizational arrangement is that the patient does not need to know any information at all about the Universal Plan, and consequently does not have to bring in a pharmacy benefit card, an incentive coupon or anything similar to take advantage of an incentive/discount program, since most or all of the incentive/discount programs currently running can all be found in the same Universal Plan at the same Universal BIN, which is already programmed into the pharmacy's claim processing system.

An additional benefit of this organizational arrangement is that, in an embodiment of the invention, more than one transaction or claim can be submitted to the Universal Plan 352 in a single transmission. The claim submission from the pharmacy 106 to the Universal Plan 352 optionally includes claim information for a plurality of pharmaceuticals. In an embodiment of the invention, the plurality of claims included in the single transmission is processed contemporaneously and/or simultaneously and/or a single claim response for the plurality of claims is transmitted back to the claim submitter 106/302. In an embodiment of the invention, multiple claim responses are returned to the claim submitter, for example, one claim response for each claim submitted, even though the claims were submitted in a single transmission originally.

Thus, referring back to FIG. 2B, a pharmacist only has to submit the Universal Plan's BIN (along with the usual patient and prescription drug information) when submitting an incentive or discount program claim in order to be directed to a plurality of contemporaneous incentive programs being run, in accordance with an exemplary embodiment of the invention. In some embodiments of the invention, most or all of the different pharmaceutical manufacturer's programs that are being run at that time are held in the Universal Plan 352 such that the pharmacist can submit the incentive/discount claim to the Universal BIN and if there is any program running for any drug for which a prescription was filled, the claims processing system will return the discount/incentive and/or co-pay offset information, for example the incentive coupon or voucher information to be used to provide the patient with a discount, without the pharmacist having to submit multiple, traditional BIN+PCN÷Group # claim processing requests for each drug and/or incentive program coupon the patient brought in.

In an embodiment of the invention, the Universal Plan allows for better management of patient utilization across multiple pharmaceuticals, for example by creating a patient portfolio that is based on a plurality of claims submitted to the Universal Plan. In some embodiments of the invention, the patient portfolio is used, for example, to help detect drug interaction issues, to monitor patient compliance with prescriptions, and/or to help identify product tie-ins, supplements and/or substitutes. In some embodiments of the invention, the patient opts-in to a patient utilization program. In some embodiments of the invention, data is scrubbed or encoded for patient identifying information in order to protect patient privacy. In some embodiments of the invention, patient enrollment or opting-in occurs at the pharmacy upon the filling of a prescription. Optionally, the enrollment is assisted by the pharmacist. In some embodiments of the invention, the patient is given information about the utilization program at the pharmacy and is provided with sufficient instructions for enrolling or opting-in at home. In an embodiment of the invention, once a patient is enrolled or has opted-in to the patient utilization program, the pharmaceutical manufactures or other interested and/or relevant parties contact the patient directly, bypassing the pharmacy.

In an embodiment of the invention, incentive claims submitted for pharmaceuticals enable entities related to the health care and/or pharmaceutical industry to gather more information about their customers and optionally, to offer additional, alternative, substitute and/or supplemental products to the patient as a result of an analysis of the patient portfolio. For example, product offerings could be made to a patient just based on the NDC submitted in the incentive claim, although generally speaking, the more information contained in the patient portfolio the more targeted and/or relevant suggestions could be. Optionally, the patient portfolio based on the Universal Plan is linked or merged with another portfolio which has been created by a pharmacy, processor and/or a pharmaceutical manufacturer and/or other related entity in order to provide as much information in the patient portfolio as possible. For example, claim submitters like pharmacies could supply additional information (e.g. phone number, mailing address, email address) about the patient filling the subscription in order to augment the information in the patient portfolio. Optionally, the additional information is supplied as a part of the nominal claim submission process. Optionally, the patient is asked to opt-in to receive communication from the payers/pharmaceutical manufacturers when the prescription is filled and/or in conjunction with receiving an incentive from the Universal Plan.

In an embodiment of the invention, patient compliance is optionally measured by calculating how long it takes the patient to use an entire prescription and/or related prescriptions (for example where more than one drug is taken in combination) before refilling it using the time difference in incentive claim submissions for the same and/or related pharmaceuticals as a measure. Optionally, if a prescription is never refilled, if for example a subsequent incentive claim is not filed to the Universal Plan for a pharmaceutical which would normally require multiple refills, then that also could be used to measure patient compliance. In an embodiment of the invention, since all of the incentive claims for the multiple pharmaceuticals are submitted to the same Universal Plan, it makes it easier to determine if the combination is being taken and/or is being taken at the proper relative rate (each drug is being consumed at the correct rate).

In an embodiment of the invention, a patient portfolio is created for a patient from the time an initial incentive claim is submitted to the Universal Plan.

In an embodiment of the invention, patients are given options for filling their prescriptions at a discount even if there is some anomalous condition which would otherwise prevent the patient from taking advantage of the incentive. For example, many primary payers impose rules and/or restrictions on the fulfillment of pharmaceutical prescriptions (e.g. the patient needs to show that the over-the-counter equivalent was tried first and that it did not work). In an embodiment of the invention, as described elsewhere herein, the pharmacy could suggest a substitute and/or alternative if for whatever reason the patient does not qualify for an incentive coupon. In some cases, the patient goes to the pharmacy to fill a prescription and the primary payer denies coverage for it. In an embodiment of the invention, there are included within the Universal Plan pre-authorized incentive coupons which could be used by a patient to get the prescription at a discounted price, regardless of the patient's coverage status with the primary payer, while the patient is still embroiled in the appeals process with the primary payer.

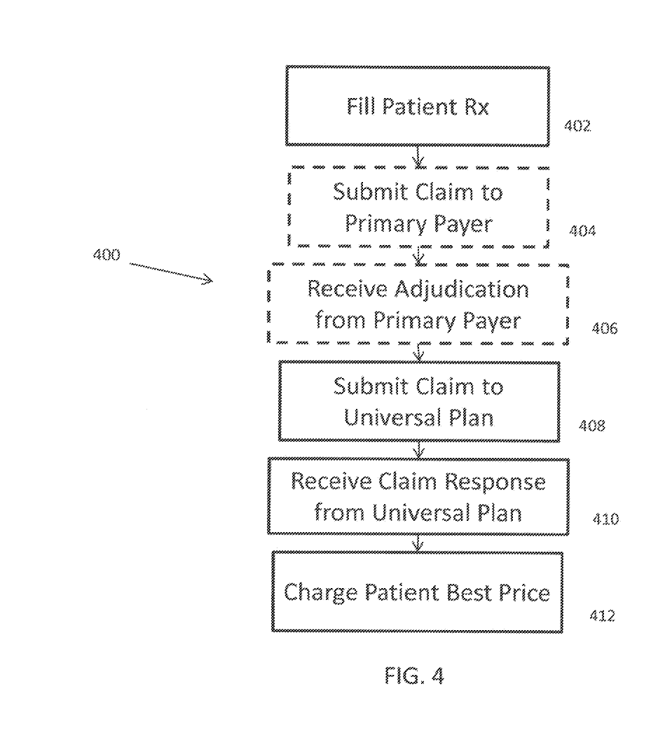

FIG. 4 is a flowchart 400 of a method of billing for filling a prescription in a co-pay offset system, in accordance with an exemplary embodiment of the invention. In an embodiment of the invention, after a patient fills (402) a prescription, the pharmacist submits (404) a claim to a primary payer. This primary claim typically involves submitting the patient's information, the prescription information and the BIN and PCN and/or Group # of the patient's health insurance and/or prescription medication plan to the claims processing system in order to have the claim adjudicated. After the claim has been accepted by the system, the pharmacist receives (406) in response to the claim submission (404) an indication about how much of the cost was covered by the primary payer and how much the patient is responsible for as a co-payment. In an embodiment of the invention, the pharmacist then submits (408) a claim to the universal discount/incentive plan using the Universal BIN. The Universal Plan claim also contains at least prescription information, for example the NDC number, so that any incentive/discount programs being run for that drag can be identified by the PBM upon receipt by the PBM of the claim.

It should be understood that in some embodiments of the invention, apart from the BIN, incentive program information can be retrieved solely by the drug's name or other identifier, like NDC. This is in contrast to other methods which require the BIN and at least the PCN anchor Group #, in addition to the drug information, in order to find the applicable incentive program.

Optionally, a primary claim is not submitted (404), it is possible that the pharmacist only submits (406) a Universal Plan 352 claim, if for example the pharmacist knows that the pharmaceutical is covered by a very aggressive incentive program in the Universal Plan which would provide a benefit that can't be beat even with submitting a primary claim first.

In some embodiments of the invention, the incentive claim submission (406) will not yield any result, that is, there is no incentive/discount program being run for that particular pharmaceutical. The pharmacist will be notified by the claims processing system if there are no programs being run for the drug or drugs submitted.

In an embodiment of the invention, once an applicable incentive/discount program has been identified by the PBM 202 in the Universal Plan 352, at least one rule of the program (a “Program Rule”) is applied to the claim. A Program Rule could pertain to the amount of incentive or discount which is to be applied, for example, a certain % off the total amount. In some embodiments, the Program Rule could be procedural/administrative, for example a primary payer claim has to be submitted first, such as at action (404), before the Universal Plan claim is submitted (408) so that the incentive program is only supplemental or an off-set to the primary payer's contribution. Optionally, more than one rule applies to the incentive program.

In some embodiments of the invention, rules are applied at the pharmacy 106 level (a “Pharmacy Rule”). Optionally, the Pharmacy Rules are pre-programmed into the pharmacy claim submission software. Examples of Pharmacy Rules include disallowing coupons for certain pharmaceuticals and/or groups and/or classes of pharmaceuticals, limiting how many product tie-in oilers are provided to the patient, and/or limiting the total financial benefit to the patient. Other Pharmacy Rules which could be applied include filtering out coupons which are being offered by a specific manufacturer or manufacturers, filtering out coupons for a pharmaceutical and/or a class or group of pharmaceuticals (for example, AB-rated generics) or the Pharmacy Rule could be, for example, only apply a coupon if the co-pay is over a certain dollar amount. In some embodiments of the invention, Pharmacy Rules are applied at a single pharmacy location. Optionally, Pharmacy Rules are applied at some or all locations of a large pharmacy chain.

After application of the rule(s) of the program, the adjudicated incentive claim is returned (410) to the pharmacist via the claim processing system so that the best price can be charged (412) to the patient. In an embodiment of the invention, the amount which is charged (412) to the patient is a combination of the primary claim return and the incentive claim return in a first scenario, or in some instances is just the primary claim return in a second scenario, or in some instances is just the incentive claim return in a third scenario. In some embodiments of the invention, particularly in the second scenario, if an incentive claim is denied, for example because there is no incentive program running or because the patient doesn't qualify to use the an incentive, a substitute and/or alternative is suggested to the patient via the pharmacist and the incentive claim response. Optionally, related products are also suggested to the pharmacist in the claim response, particularly for related products for which there is an incentive program running, which could also be a part of the Universal Plan.

In an embodiment of the invention, patient compliance with the doctor's prescription drug plan for the patient's treatment is enhanced by using the Universal Plan system to reduce the cost of prescription drugs for the patient. In addition, because no card is needed by the patient to reap the benefit of the incentive programs within the Universal Plan, there is less hassle for the patient in not having to remember to carry around a card or coupon to redeem at the pharmacy.

In some embodiments of the invention, prior authorization incentive coupons are offered to patients through the Universal Plan whose primary payment benefits are unknown and/or are being disputed by the primary payer and the patient. The prior authorization incentive coupons provide the prescribed pharmaceutical at a discount to enhance the likelihood that the patient will fill and pick up the prescription even though the extent of the patient's prescription drug insurance coverage is uncertain.

In order to more specifically illustrate the universal prescription co-pay offset system and methods for its use, an exemplary scenario is now described. A patient goes to a doctor's office complaining of a gastro-intestinal ailment. The doctor evaluates the patient and recommends that the patient begin taking Nexium®, a prescription drug. The doctor writes a prescription for Nexium® which the patient must fill at a pharmacy. The patient takes the prescription to the pharmacy to be filled (and/or the prescription is electronically transmitted to the pharmacy) and the pharmacist fills the Nexium® prescription.

In order to determine how much the patient has to pay, the pharmacist submits a claim to the patient's health insurance company (the primary payer), Independence Blue Cross Blue Shield. Ideally, the patient presents the pharmacist with at least the name of the insurance company and/or gives the pharmacist the patient's health insurance card. The pharmacist submits a claim, possibly including patient information and prescription information, to the BIN associated with Independence Blue Cross Blue Shield which routes the claim to the PBM associated with Independence Blue Cross Blue Shield, who then uses the PCN and/or Group # to determine how much of the cost of the prescription the primary payer will pay. In this example let's say foe Nexium® prescription costs $300and the co-pay under the patient's plan with Independence Blue Cross Blue Shield is $75. So the adjudicated primary claim return indicates to the pharmacist that the patient has to pay $75. The pharmacist then submits a supplemental incentive benefit claim to the Universal Plan using the Universal BIN and also providing at least an identification of the drug, Nexiunr®.

In a first scenario where there is an incentive program running for Nexiurn® and it is a part of the Universal Plan, the PBM applies the rules of the program (in this example 50% off of the co-pay) and provides the adjudicated incentive claim return, which the pharmacist uses to charge the patient 50% off of $75, so $37.50 total will be charged to the patient.

In a second scenario, the pharmacist submits the incentive claim and discovers that there is no program running for Nexlum® in the Universal Plan, thus the patient is charged the full co-pay amount of $75.

In a third scenario, when the pharmacist submits the incentive claim to the Universal Plan, the incentive program which is running is the same or better than applying the combination of the primary claim return and the incentive claim return, for example the incentive program says that the most the patient should pay for a Nexium® prescription, regardless of what the primary payer is willing to pay, is $20. In this third scenario, the pharmacist would simply apply the incentive program claim return without first applying the primary payer's claim response. Optionally, the pharmacist already knows this program is running for Nexiurn®, so when a patient comes in to fill a prescription for Nexium® the pharmacist skips submitting a primary claim altogether knowing that the incentive program which is running is going to provide the same or better result for the patient than combining the primary payer with the incentive program.

It is expected that during the life of a patent maturing from this application many relevant patient incentives or compliance techniques will be developed and the scope of the term “coupon” is intended to include all such new technologies a priori.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein, interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application, was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for submitting a claim to a plurality of incentive programs to off-set a patient's financial responsibility for a pharmaceutical prescription, comprising:
commencing the filling of a patient prescription;
submitting at least a claim for the prescription, using a pre-programmed claim submission system, to a Universal Plan comprised of a plurality of incentive programs using a single Universal BIN associated to the Universal Plan by the claim submission system;
receiving a claim response from the Universal Plan; and,
charging the patient based on information received in the claim response from the Universal Plan.

2. A method according to claim 1, further comprising submitting a primary payer claim.

3. A method according to claim 2, wherein charging is based on information received from adjudicated claims submitted to at least one of the primary payer and the Universal Plan.

4. A method according to claim 1, wherein the submitting is performed using only the Universal BIN and drug identification information.

5. A method according to claim 1, wherein receiving a claim, response incorporates the application of at least one rule.

6. A method according to claim 5, wherein at least one rule is a Program Rule or a Pharmacy Rule.

7. A method according to claim 1, further comprising creating a patient profile based on at least one filling of a prescription by the patient.

8. A method according to claim 7, further comprising offering at least one additional incentive to the patient based on the patient's profile.

9. A method according to claim 7, wherein the patient voluntarily enrolls in a program to utilize information in the patient profile.

10. A method according to claim 7, wherein at least some of the patient profile is encoded to enhance patient privacy.

11. A method for organizing prescription pharmaceutical plans, comprising:
associating a plurality of individual plans with a single Universal Plan; and,
associating the Universal Plan with a single Universal BIN routed to a single PBM.

12. A method according to claim 11, wherein the plurality of individual plans are offered by a plurality of different payers.

13. A method according to claim 11, wherein a claim submitted to the Universal Plan is processed for applicability to each of the plurality of individual plans associated with the Universal Plan.

14. A method for increasing patient compliance with a health care professional created prescription medication treatment plan, comprising:
providing a Universal Plan with a Universal BIN, wherein multiple incentive programs are associated with the Universal Plan;
filling a patient prescription at a pharmacy;
submitting a pharmaceutical benefit claim for the filled patient prescription using a pre-programmed claim submission system at the pharmacy; and,
increasing patient compliance by saving the patient money as a result of submitting the pharmaceutical benefit claim and receiving an adjudicated claim response which applies an incentive coupon to the prescription.

15. A method according to claim 14, wherein the incentive coupon is a prior authorization coupon.

16. A system for processing prescription pharmaceutical claims submitted to a plurality of plans, comprising:
at least one claim submitting computer located at a pharmacy, programmed with a Universal BIN associated with a Universal Plan comprised of a plurality of incentive plans;
a PBM configured to process a Universal Plan claim by identifying at least one drug which is the subject of the claim, wherein the Universal Plan is organized at the PBM to include a plurality of incentive plans; and,
a communications network operatively connected to the at least one computer and the PBM for relaying information between them.

17. A system according to claim 16, wherein the at least one computer is provided with a memory for storage of at least one of a software for programming the computer, patient information and rules.

18. A system according to claim 16, wherein the information is comprised of a transmission of a claim from the pharmacy and a claim response to the pharmacy from the PBM.

19. A system according to claim 16, further comprising a pharmaceutical manufacturer in communication with at least one of the pharmacy and the PBM for the transmission of rules and patient information.

20. A system according to claim 16, further comprising a primary payer in communication with at least one of the pharmacy and the PBM for processing a primary payer claim alternatively, additionally or preceding a claim to the Universal Plan.
